(19) United States
(12) Patent Application Publication
(10) Pub. No.: US 2007/0193657 A1
(43) Pub. Date: Aug. 23, 2007

(54) Method For Producing Powder Compound Cores Made From Nano-Crystalline Magnetic Material

(76) Inventor: Markus Brunner, Bessenbach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/677,818

(22) Filed: Feb. 22, 2007

(30) Foreign Application Priority Data
Feb. 22, 2006 (DE) 10 2006 008 283.4

(51) Int. Cl. H01F 1/03

(52) U.S. Cl. 148/105

(57) ABSTRACT

In a method for producing a compressed powder compound core from a nano-crystalline alloy of the composition FeSiCuNbB, the alloy powder used for producing the magnetic core is compressed in an amorphous state.

### RELATED APPLICATION

This application claims priority from German Patent Application No. DE 10 2006 008 283.4, which was filed on Feb. 22, 2006, and is incorporated herein by reference in its entirety.

### TECHNICAL FIELD

The invention relates to a method for producing powder compound cores made from nano-crystalline magnetic material (e.g., Vitroperm of the company Vacuumschmelze)

### BACKGROUND

The use of magnetic cores made from soft-magnetic powder materials is state of the art for the use as low-permeable storage or filter throttles. In the simplest case these cores are made by compressing ferrous powder or iron alloy powder (e.g., FeSi, FeAlSi, NiFe). Most recent developments also describe the production of these cores from alloys typically used for producing quick-setting tapes, e.g., on a basis of FeSiB.

All these alloy variants have in common that they relate either to materials with comparatively high magnetostriction or alloys with a relatively low specific electric resistance. In case of a compressed powder core this leads to cores with an increased loss magnetic loss at higher frequencies, which are caused either by comparatively high hysteresis due to magnetostriction or by an increased intra-particular loss of eddy current in better conductive variants.

Here, the use of an alloy based on FeSiCuNbB (Vitroperm) offers the advantage that a practically magnetostriction free alloy is used with a very high specific resistance.

These advantageous features are only achieved by a heat treatment at temperatures >500° C., which, in addition to the formation of a nano-crystalline structure responsible for the good soft-magnetic features, also leads to an extreme brittleness of the alloy, which in this state practically excludes a pressure-molding of the material. When it is attempted to press a nano-crystalline powder from this material, instead of a compression and compacting only an additional grinding of the flakes made from the quick-setting tape occurs in the pressure tool. This additional grinding in the pressure tool with the new formation of electrically not insulated waste edges results in a very high electric volume conductivity of the molding and thus during operation leads to high electric loss in the form of loss of eddy current inside the magnetic core.

### SUMMARY

The object of the present invention is therefore to provide a production method, which allows the processing of a FeSiCuNbB-alloy (Vitroperm) by way of compression for the production of a powder compound core.

In order to realize that it is provided, on the one hand, after the production of the amorphous tape, first to transfer the very ductile Vitroperm into a condition, at which the rational grinding into a powder (and/or flakes) is possible, which on the other hand, results in the material still being ductile to such an extent that during compression in the tool with pressures ranging from 1-20 t/cm² no additional grinding of the material occurs.

Therefore, a method for producing a compressed powder compound core from a tape of nano-crystalline alloy of the composition FeSiCuNbB, may comprise the step of producing alloy powder from said tape, and compressing the alloy powder used for producing the compressed powder compound core in an amorphous state.

### DETAILED DESCRIPTION

It has been found that a sufficient brittleness for grinding Vitroperm tape can be achieved by a heat treatment of the tape at temperatures ranging from 200 to 400° C. for a period from 0.5 to 8 hours under protective gas in connection with grinding temperatures between room temperature and the temperature of liquid nitrogen. This produces a powder (flakes), which has sufficient ductility for further processing into compressed cores.

The actual molding of the magnetic cores by compression in a tool occurs then generally at a temperature above the temperature of the previous heat treatment for achieving brittleness. This way it is achieved that the powder (flakes) in the compression tool behaves entirely ductile and any additional mechanical grinding of the powder during compression is prevented.

In order to further process the ground Vitroperm powder (flakes) into compressed cores first a coating of the material occurs for an electrical insulation of the individual particles in order to suppress the formation of volume eddy current in the compressed magnetic core to the extent possible. For this purpose, essentially mineral coatings are suitable that have a sufficient temperature tolerance for the final heat treatment at 540-580° C. For this purpose, e.g., coatings based on ferrous phosphate, different silicate coatings, (e.g., Na-silicate, K-silicate, Mg-silicate) or also organic materials forming SiO₂, as well, such as e.g. silane can be used. Furthermore, the use of very fine-grain (<2 μm) ceramics, e.g., based on MgO, Al₂O₃ or SiO₂ are possible as the electrically insulating spacers between the individual magnetic particles. Appropriately high-temperature tolerant polymer binders are used as additional components of the compression mixture. Generally suitable for this purpose are polymers of the group of phenol resins, polyimides, and/or special silicon resins. Furthermore, the mixture contains a lubricant effective at the compression temperatures used as a processing agent.

### EXEMPLARY EMBODIMENTS

1. A tape having the composition FeSiCuNbB and a thickness of 18 μm was heat treated for 8 hours at 200° C. under nitrogen and subsequently at room temperature cut in a mill into flakes with an edge length <6 mm. These pre-milled flakes were cooled in 1N₂ and then in an impact mill ground into flakes with an edge length <160 μm at the temperature of liquid nitrogen.

The flakes produced in this manner are provided with an insulating coating made from ferrous phosphate by an etching treatment using a mixture of acetone and phosphoric acid.

| | | |
|---|---|---|
| Vitroperm flakes phophatized | 96% | by weight |
| Agent (phenol and silicon resin) | 3.8% | by weight |
| Lubricant | 0.2% | by weight |

This mixture is compressed at temperatures of 250° C. and a pressure of 6 t/cm².

Subsequent to the molding the green body is subjected to a heat treatment, which leads to nano-crystallization of the magnetic alloy. For this purpose the green body is heated for 2 hours to a temperature of 550° C. under nitrogen.

The magnetic core produced in this manner had a relative permeability of 56 and a magnetic loss at 100 kHz and an induction of 0.1 T of 620 mW/cm³.

2. A tape of the composition FeSiCuNbB and a thickness of 17 μm was heat treated for 4 hours at 250° C. under nitrogen and subsequently at room temperature it was milled in a cutting mill into flakes with an edge length <6 mm. These pre-milled flakes were cooled in 1N₂ and then in an impact mill ground into flakes with an edge length <160 μm at the temperature of liquid nitrogen.

The flakes produced in this manner are provided with an insulating coating made from ferrous phosphate by an etch treatment with a mixture of acetone and phosphoric acid. From the magnetic powder prepared in this manner the following mixture is produced:

| | | |
|---|---|---|
| Vitroperm flakes phophatized | 96% | by weight |
| Agent (phenol and silicon resin) | 3.8% | by weight |
| Lubricant | 0.2% | by weight |

This mixture is compressed at a temperature of 270° C. and a pressure of 6 t/cm2.

Subsequently to the molding the green body is subjected to a heat treatment, which leads to nano-crystallization of the magnet alloy. For this purpose the green body is heated for 2 hours to a temperature of 550° C. under nitrogen.

The magnetic core made in this manner had a relative permeability of 58 and magnetic loss at 100 kHz and an induction of 0.1 T of 580 mW/cm³.

3. A tape of the composition FeSiCuNbB and a thickness of 19 μm was heat treated for 2 hours at 300° C. under nitrogen and subsequently at room temperature it was milled in a cutting mill into flakes with an edge length <6 mm. These pre-milled flakes are cooled in 1N₂ and then at a temperature of approx. −80° C. ground to flakes with an edge length <160 μm in an impact mill. The flakes produced in this manner are provided with an insulating coating made from ferrous phosphate by an etch treatment with a mixture of acetone and phosphoric acid. From the magnetic powder prepared in this manner the following mixture is produced:

| | | |
|---|---|---|
| Vitroperm flakes phophatized | 96% | by weight |
| Agent (silicon resin) | 3.9% | by weight |
| Lubricant | 0.1% | by weight |

This mixture is compressed at a temperature of 320° C. and a pressure of 8 t/cm².

Subsequent to the molding the green body is subjected to a heat treatment, which leads to nano-crystallization of the magnet alloy. For this purpose the green body is heated for 1 hour to a temperature of 565° C.

The magnetic core made in this manner had a relative permeability of 63 and magnetic loss at 100 kHz and an induction of 0.1 T of 380 mW/cm³.

4. A tape of the composition FeSiCuNbB and a thickness of 20 μm was heat treated for 1 hour at 350° C. under nitrogen and subsequently at room temperature it was milled in a cutting mill into flakes with an edge length <6 mm.

These pre-milled flakes are then ground at room temperature to flakes with an edge length <160 μm in an impact mill.

The flakes produced in this manner are provided with an insulating coating made from ferrous phosphate by an etch treatment with a mixture of acetone and phosphoric acid. From the magnetic powder prepared in this manner the following mixture is produced:

| | | |
|---|---|---|
| Vitroperm flakes phophatized | 96.4% | by weight |
| Agent (silicon resin) | 3.5% | by weight |
| Lubricant | 0.1% | by weight |

This mixture is compressed at a temperature of 380° C. and a pressure of 8 t/cm².

Subsequently to the molding the green body is subjected to a heat treatment, which leads to nano-crystallization of the magnet alloy. For this purpose the green body is heated for 1 hour to a temperature of 560° C.

The magnetic core made in this manner had a relative permeability of 64 and magnetic loss at 100 kHz and an induction of 0.1 T of 420 mW/cm³.

5. A tape of the composition FeSiCuNbB and a thickness of 18 μm was heat treated for 1 hour at 400° C. under nitrogen and subsequently at room temperature it was milled in a cutting mill into flakes with an edge length <6 mm.

These pre-milled flakes are then at room temperature ground to flakes with an edge length <160 μm in an impact mill.

The flakes produced in this manner are provided with an insulating coating made from ferrous phosphate by an etch treatment with a mixture of acetone and phosphoric acid. From the magnetic powder prepared in this manner the following mixture is produced:

| | | |
|---|---|---|
| Vitroperm flakes phophatized | 96.4% | by weight |
| Agent (phenol and silicon resin) | 3.5% | by weight |
| Lubricant | 0.1% | by weight |

This mixture is compressed at a temperature of 410° C. and a pressure of 8 t/cm².

Subsequently to the molding the green body is subjected to a heat treatment, which leads to nano-crystallization of the magnet alloy. For this purpose the green body is heated for 1 hour to a temperature of 570° C.

The magnetic core made in this manner had a relative permeability of 60 and magnetic loss at 100 kHz and an induction of 0.1 T of 480 mW/cm³.

What is claimed is:

1. A method for producing a compressed powder compound core from a tape of nano-crystalline alloy of the composition FeSiCuNbB, comprising the step of:
producing alloy powder from said tape, and
compressing the alloy powder used for producing the compressed powder compound core in an amorphous state.

2. The method according to claim 1, wherein prior to a grinding and the compressing a heat treatment is performed between 200 and 400° C. under a protective gas, which causes an intended brittling of the tape for the grinding, however does not negatively influence the ductility of flakes at the compression temperatures.

3. The method according to claim 2, wherein depending on the temperature of the brittleness treatment the grinding of the pre-tempered tape occurs at temperatures between the temperature of liquid nitrogen and maximally room temperature.

4. The method according to claim 2, wherein a molding occurs by compression at temperatures above the temperature of the first heat treatment for the targeted brittling of the source tape, in order to safely exclude a further milling of magnetic material by breakage due to brittleness.

5. The method according to claim 1, wherein the heat treatment of the magnetic core, to adjust soft-magnetic features connected to the nano-crystalline structures, occurs subsequently to the molding at temperatures between 540 and 580° C. and under a protective gas.

6. A method for producing a compressed powder compound core comprising the steps of:
grinding an alloy powder from nano-crystalline alloy of the composition FeSiCuNbB, and
compressing the alloy powder in an amorphous state.

7. The method according to claim 6, wherein prior to the steps of grinding and compressing a heat treatment is performed.

8. The method according to claim 7, wherein the heat treatment is performed between 200 and 400° C.

9. The method according to claim 7, wherein the heat treatment is performed under a protective gas which causes an intended brittling of the material for grinding, however does not negatively influence the ductility of grinding flakes at the compression temperatures.

10. The method according to claim 9, wherein depending on the temperature during brittling the grinding of the heat treated alloy occurs at temperatures between the temperature of liquid nitrogen and maximally at room temperature.

11. The method according to claim 7, wherein the molding occurs by compression at temperatures above the temperature of the first heat treatment for the targeted brittling of the alloy, in order to safely exclude a further milling of magnetic material by breakage due to brittleness.

12. The method according to claim 7, wherein to adjust soft-magnetic features connected to nano-crystalline structures the heat treatment of the magnetic core occurs subsequently to the compressing.

13. The method according to claim 12, wherein the heat treatment is performed at temperatures between 540 and 580° C.

14. The method according to claim 12, wherein the heat treatment is performed under a protective gas.
